(19) United States
(12) Patent Application Publication
(10) Pub. No.: US 2014/0304291 A9
(43) Pub. Date: Oct. 9, 2014

(54) Computer method for searching document and recognizing concept with controlled tolerance

(71) Applicant: Sizhe Tan, Berkeley, CA (US)

(72) Inventor: Sizhe Tan, Berkeley, CA (US)

(21) Appl. No.: 13/385,735

(22) Filed: Mar. 5, 2012

Related U.S. Application Data
(63) Continuation-in-part of application No. 12/699,972, filed on Feb. 4, 2010.
Application No. 12/699,972 is a continuation of application No. 11/636,857, filed on Dec. 11, 2006, now Pat. No. 7,689,620.
(60) Provisional application No. 60/808,180, filed on May 24, 2006.

(51) Int. Cl. G06F 17/30

(52) U.S. Cl. 707/769; 707/E17.014

(57) ABSTRACT

Documents are searched by a target document. The target document is tokenized into buta strings. The buta strings are decomposed into buta attribute values. A target buta attribute value is selected. A tolerance is given to the target buta attribute value. A buta attribute range is determined from the given tolerance. Buta attribute value suggestions are lookup results within the buta attribute range in dictionary of index II, which relates a buta attribute value to buta strings. Alternative buta strings are searched using the buta attribute value suggestions in dictionary of index II. Finally, documents can be searched using the alternative buta strings in dictionary of index I, which relates a buta string to documents.

### CROSS-REFERENCE TO RELATED APPLICATIONS

Reference is made to my U.S. Pat. No. 7,689,620 (Issue Date Mar. 30, 2010) and US Publication 2010/0153402 (Pub. Date Jun. 17, 2010).

### BACKGROUND

Recent progress of word-based information retrieval, especially related to an Internet document search, has been much more advanced than non-word-based information retrieval. Non-word-based information includes images and stock documents, among others. In contrast to word-based information that contains strings of words, non-word-based information contains data over an n-dimensional space, and each datum comprises a plurality of values from m measurements, where m and n are integers.

For example, non-word-based information includes images, photographs, and pictures. An image shows a value or a combination of values over a two-dimensional array. A picture can be a regular color picture taken by a camera, an X-ray picture, an infrared picture, an ultrasound picture, etc. There was no efficient and systematic way to search a specific image of interest (e.g., an eye) embedded in an image document (e.g., a human face), which was stored in a stack of image documents (e.g., various pictures), until a method for searching non-word-based documents, particularly image documents, is recently disclosed in US Publication 2010/0153402, which is incorporated by reference.

An image document is tokenized into image pattern tokens. Image pattern tokens from all tokenized documents are collected in a master collection of image pattern tokens. Upon receiving a query, image pattern tokens of the query are search within the master collection. The documents related to the matching image pattern tokens can be found. However, without search tolerance, it may be less likely to find specific image pattern tokens in the master collection.

### SUMMARY

This and other drawbacks of the prior art are overcome by the present disclosure, as described herein in detail.

According to one aspect, the disclosure is directed to an image document search by a query. The query is tokenized into image pattern tokens. Then the image pattern tokens are represented by buta strings. The buta strings are decomposed into buta attribute values. A target buta attribute value is selected. A tolerance is given to the target buta attribute value. A buta attribute range is determined from the given tolerance. Buta attribute value suggestions are found within the buta attribute range in dictionary of index II. Alternative buta strings are searched using the buta attribute value suggestions in dictionary of index II. Finally, image documents can be searched using the alternative buta strings in dictionary of index I.

According to another aspect, the disclosure is directed to a document search by a target document. The target document is tokenized into buta strings. The buta strings are decomposed into buta attribute values. A target buta attribute value is selected. A tolerance is given to the target buta attribute value. A buta attribute range is determined from the given tolerance. Buta attribute value suggestions are found within the buta attribute range in dictionary of index II. Alternative buta strings are searched using the buta attribute value suggestions in dictionary of index II. Finally, documents can be searched using the alternative buta strings in dictionary of index I.

According to yet another aspect, the disclosure is directed to concept recognizing by a computer. A target concept is tokenized into buta strings. The buta strings are decomposed into buta attribute values. A target buta attribute value is selected. A tolerance is given to the target buta attribute value. A buta attribute range is determined from the given tolerance. Buta attribute value suggestions are found within the buta attribute range in dictionary of index II. Alternative buta strings are searched using the buta attribute value suggestions in dictionary of index II. Finally, concepts can be recognized as referred to the target concept using the alternative buta strings in dictionary of index I.

### BRIEF DESCRIPTION OF THE DRAWINGS

The foregoing and other features and advantages of the disclosure will be apparent from the more particular description of preferred embodiments, as illustrated in the accompanying drawings, in which like reference characters refer to the same parts throughout the different views. The drawings are not necessarily to scale, emphasis instead being placed upon illustrating the principles of the disclosure.

FIG. 1 shows a system for tokenizing image documents.

FIG. 2 shows an image document partitioned into an array of cells, each cell consists of a plurality of pixels.

FIG. 3 shows four alternative buta strings satisfying the search using buta attribute value suggestions.

FIG. 4 shows three documents resulting from the search using alternative buta strings.

FIG. 5 contains a process for searching image documents.

FIG. 6 shows a concept or a document tokenized into a plurality of buta strings.

FIG. 7 shows each buta string split into a plurality of buta attribute values.

FIG. 8 is an example of dictionary of index I.

FIG. 9 is an example of dictionary of index II.

FIG. 10 contains a process for constructing dictionaries of index I and II.

### DETAILED DESCRIPTION

Embodiments are illustrated by way of example, and not by way of limitation. According to the present disclosure, an image pattern token is represented with a buta (biological unit text abstraction) string. A buta string is decomposed into buta attribute values. A tolerance is given to a target buta attribute value, such that a tolerance range can be determined. Buta attribute value suggestions are lookup results within the range in a buta attribute value dictionary. The tolerance range will increase the likelihood to find a matching buta attribute value in the buta attribute value dictionary. Accordingly, the likelihood of finding a matched image document is increased.

### Tokenizing of Image Documents

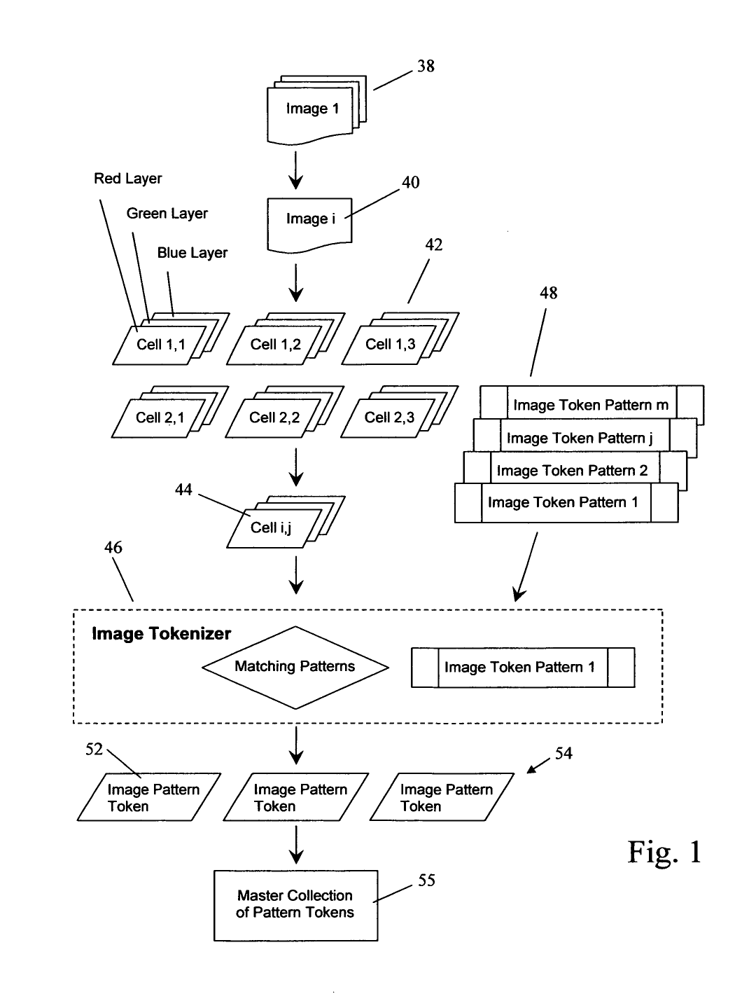

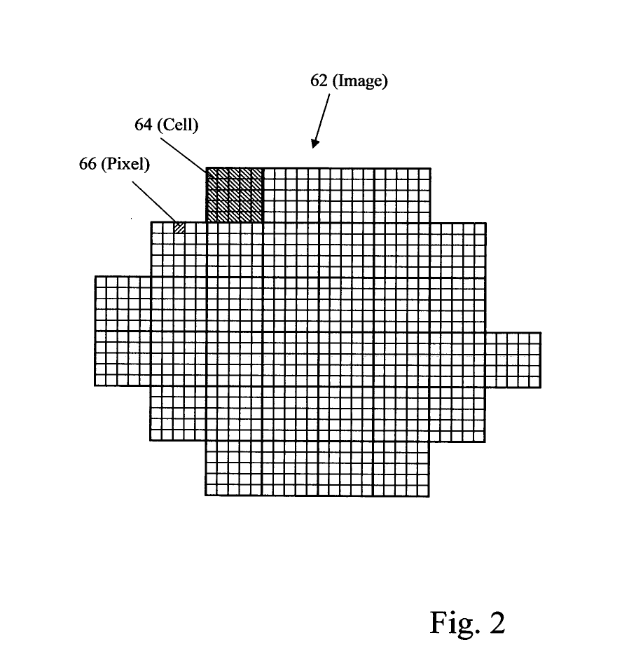

FIG. 1 is a system for tokenizing image documents. FIG. 2 shows an image document 62 partitioned into an array of cells 64. Each cell 64 consists of a plurality of pixels 66.

The image search system is used to find an image document or documents that contain a specific feature or pattern. For example, a user may inquire what maps (image documents) contain a specific landmark such as the Golden Gate bridge. The query may be in the form of an aerial picture of the Golden Gate bridge. The image document search system will output a number of maps that contain picture of the Golden Gate bridge.

In another example, a collection of millions of satellite pictures are provided. A picture is then randomly picked up from the collection. The picture is cut into pieces. A piece of the picture is used as a reference or a query. The image document search system will be able to find the original picture to which the piece belongs, in a collection of millions pictures, and find the position of that piece in the found picture.

FIG. 1 shows the tokenizing process. A group of image documents are collected to form a collection of image documents 38. The documents can be collected from the Internet, or they are already in a supplied or available data source. Image 1 is shown on top, followed by further documents (shown behind Image 1). Each document in collection of documents 38 will be processed one by one. FIG. 1 shows that a document 40, Image i, is being processed. Image document 40 is first split into three color layers: Red (R), Green (G), and Blue (B). Each layer is then divided into an array of cells 42. Each cell is labeled by its position (i,j) in the array. A cell has three layers and thus it has Red (R), Green (G), and Blue (B) values.

Every cell of array 42, such as Cell i,j or 44, is input individually to an image tokenizer 46. Tokenizer 46 will produce a set of tokens for each document analogous to the operation of a tokenizer in a word-based search engine. Tokenizer 46 matches input Cell i,j against a series of predefined image token patterns 48, including Image Token Pattern 1, Image Token Pattern 2, Image Token Pattern j, and Image Token Pattern m, which represent different features or patterns in an image. For example, it might be the image of an eye in a human face. The predefined image token patterns 48 may be independent and not derived from image document 40.

When tokenizer 46 matches input Cell i,j or 44 with Image Token Pattern 1, tokenizer 46 outputs an image pattern token 52. An image pattern token in non-word-based image document search is analogous to a token in word-based document search. While in a word-based document search, a token is simply a word or a combination of words, in a non-word-based image document search, a pattern token is not only represented by a word or name, it also carries an attribute. For example, an image pattern token may have a name R70_G20_B60 for searching purpose. This name may mean average intensity in red is in the range of 70-79, green is in the range of 20-29, and blue is in the range of 60-69.

As stated, an image token pattern is a reference pattern for finding an image pattern token in an image document. If a portion of the image document matches with a given image token pattern, a corresponding image pattern token is extracted from that document. Thus an image pattern token is a token which represents a pattern, feature, or attribute found in a document. For example, a token may represent a tricolor intensity feature of a cell found in an image document. Each image pattern token is provided with a name. In other words, an image pattern token has a word-based name. In the example given above, the name can be R70_G20_B60 to show that it features a tricolor intensity such that average intensity in red is in the range of 70-79, green is in the range of 20-29, and blue is in the range of 60-69. In fact, the name can be any word, which will be used in the same way as a word-based token is used in the searching process.

The tokenizer then again compares input Cell i,j or 44 repeatedly against Image Token Patterns 2, j, . . . m. If input Cell i,j or 44 is the same as the tested image token pattern, a corresponding image pattern token will be output, for example, image pattern token R90_G210_B60, image pattern token R80_G140_B160, etc. The tokenizing process is again repeated for every other cell of image document 40.

Accordingly, image document 40 will be decomposed into a collection of image pattern tokens 54. All documents in collection 38 are tokenized and decomposed into their image pattern tokens. Finally, image pattern tokens 54 from all documents in collection 38 are collected in a master collection of image pattern tokens 55. Master collection 55 is then indexed and may be searched over using a known word-based search engine similar to the known word-based document search.

An example of image document search is given in the following discussion to better understand the embodiment shown in FIG. 1. For example, assume that image document 40 shows a bucket of flowers in a garden (not shown). The document is named Flower in the following discussion.

Image document Flower is partitioned by a grid to form an array of cells as shown in FIG. 2. Each cell further consists of a plurality of pixels. For example, a cell consists of 5×5 pixels. Its values in the Red layer are shown in the following table:

| | | | | |
|---|---|---|---|---|
| 36 | 148 | 220 | 84 | 56 |
| 44 | 180 | 228 | 124 | 22 |
| 34 | 44 | 124 | 44 | 0 |
| 30 | 123 | 127 | 12 | 12 |
| 12 | 12 | 110 | 12 | 12 |

The table shown above is an exemplary Cell i,j or 44. The table has five columns and five rows, making 25 squares. Each square is a pixel of Cell i,j or 44. Cell i,j or 44 has 25 pixels. The number in each square indicates the Red layer value (intensity in red) in that pixel.

For example, one may use a method that simply takes an average over all pixel color values in a cell to define the desired image token patterns 48. The average Red value of the cell shown in the table above is 74.

For example, an image token pattern (from series of patterns 48) is defined as a cell having average Red, Green and Blue values 74, 23, and 66, respectively. For further example, tokenizer 46 matches input Cell i,j or 44 with Image Token Pattern j, which is a cell having average Red, Green and Blue values 74, 23, and 66, respectively. Tokenizer 46 outputs an image pattern token 52 with a name such as R74_G23_B66 that matches the image token pattern, which is a cell having average Red, Green and Blue values 74, 23, and 66, respectively.

For example, after the tokenizing process, master collection of image pattern tokens 55 includes {R74_G23_B66, R56_G124_B145, R77_G124_B145, R198_G124_B145, . . . }. If a query includes an image pattern token R74_G23_B66, the image document having the same image pattern token R74_G23_B66 will be found.

However, the master collection may not have the exactly same image pattern token R74_G23_B66, instead the master collection has a slightly different image pattern token R75_G23_B66. In this case, the image document having image pattern token R75_G23_B66 will be missed and is not found.

Although an image pattern token may be defined as R70_G20_B60, such that average intensity in red is in the range of 70-79, green is in the range of 20-29, and blue is in the range of 60-69, a better method may be required. A method providing controlled tolerance search is described as follows.

### Controlled Tolerance Search

“Buta” is an abbreviation of biological unit of text abstraction. A buta string represents a computer searchable string, for example, such as “abc2387xy56”. A buta format explains the meaning of the buta string. Referring to the buta format, a buta string can be split into segments or elements called buta attribute values. Each buta attribute value is associated with a buta attribute format.

For example, a query has an image pattern token R74_G23_B66. The image pattern token can be represented by a buta string 74_{—}23_{—}66. The buta format explains the buta string 74_{—}23_{—}66 representing Red, Green, and Blue average values of a cell, respectively. The buta string 74_{—}23_{—}66 can be split into 74, 23, and 66, which are buta attribute values. The buta attribute formats are, Red average value, Green average value, and Blue average value, respectively.

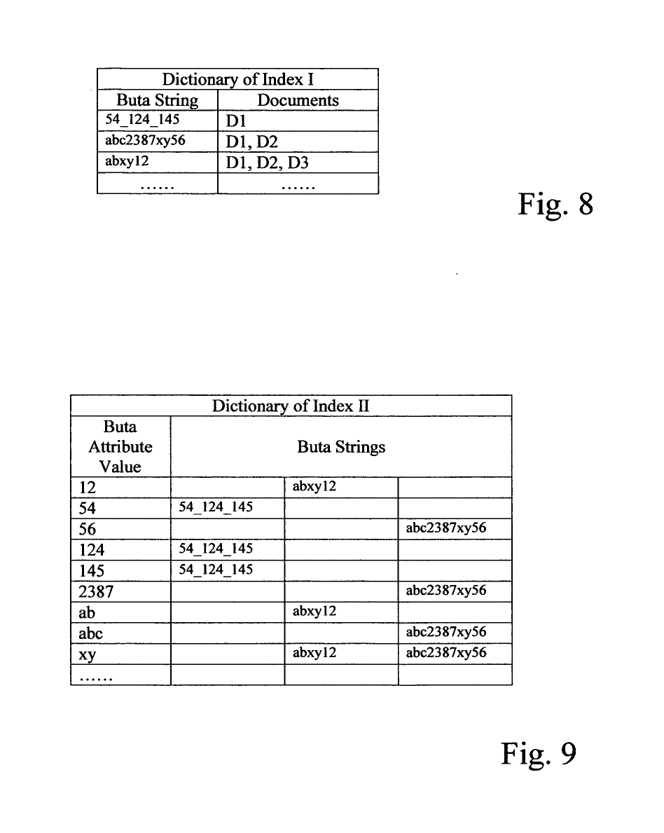

Image pattern tokens 54 in master collection 55 are represented with buta strings. Furthermore, the buta strings are decomposed into their buta attribute values. Buta attribute values of the same type are kept in the same place in an dictionary of index II. There are two kinds of dictionaries of index. Dictionary of index I relates a buta string to image documents (see, for example, FIG. 8). Thus, dictionary of index I is similar to master collection of image pattern tokens 55. Master collection of image pattern tokens 55 is transformed into dictionary of index I by representing image pattern tokens 54 with buta strings. Dictionary of index II relates a buta attribute value to buta strings (see, for example, FIG. 9). Dictionary of index II is also called buta attribute value dictionary, in which buta attribute values are sorted in ascending order. Dictionary of index II is constructed by decomposing buta strings into buta attribute values.

For clarity, first we will describe the Red average value only. For example, one may select buta attribute value 74 as a target buta attribute value. Then a tolerance is given, for example the tolerance is +/−2. A buta attribute range [72, 76] can be determined from the given tolerance.

With a buta attribute range, we can retrieve all buta attribute values within the range in the buta attribute value dictionary or dictionary of index II. The resultant values are called buta attribute value suggestions for the target buta attribute value. For example, for buta attribute range [72, 76], we may retrieve {72, 73, 75} three buta attribute values. They are the suggestions for the target buta attribute value 74.

With buta attribute value suggestions for a target buta attribute value, we search the value of OR combination of buta attribute suggestions, instead of searching the target buta attribute value. For example, for buta attribute value suggestions {72, 73, 75}, we search (72 OR 73 OR 75) instead of the target buta attribute value 74. Notice that value 74 is not in dictionary of index II, direct search for value 74 will find no matching item in dictionary of index II.

We now look at an example of image document search. For example, the query is tokenized into image pattern tokens including R56_G124_B145. The image pattern token R56_G124_B145 is represented by a buta string 56_{—}124_{—}145 for color RGB. There are three buta attribute values 56, 124, and 145 for R, G, and B, respectively. One may select all three buta attribute values 56, 124, and 145 for the target buta attribute values. Given tolerance +/−5 for the three target buta attribute values 56, 124, and 145, we have three buta attribute ranges [51, 61], [119, 129], and [140, 150].

For example, we find buta attribute value suggestions {54, 55, 57}, {120, 123, 128}, and {144, 148} for RGB, respectively, in their respective dictionaries of index II. In other words, instead of searching span {56, 124, 145} of the query in RGB dictionaries of index II, we search spans {(54 OR 55 OR 57), (120 OR 123 OR 128), (144 OR 148)} in RGB dictionaries of index II.

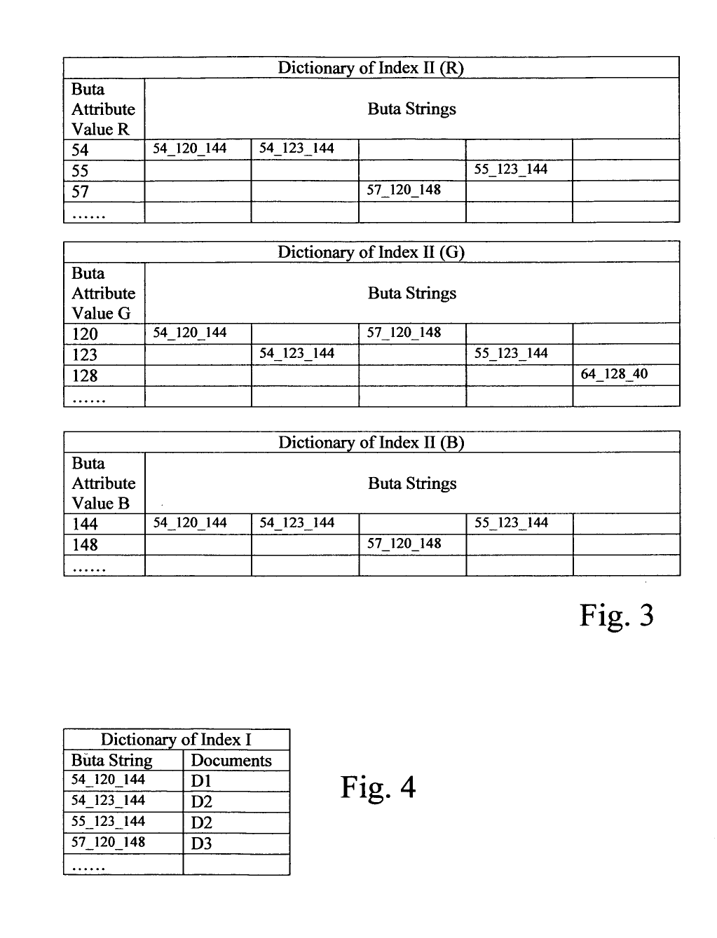

Notice that the matches from search of {(54 OR 55 OR 57), (120 OR 123 OR 128), (144 OR 148)} must be from the same buta strings. Referring to FIG. 3, for example, the search may result in four alternative buta strings: 54_{—}120_{—}144, 54_{—}123_{—}144, 55_{—}123_{—}144, and 57_{—}120_{—}148 for the target RGB string 56_{—}124_{—}145. In other words, only four alternative buta strings satisfy the lookup of {(54 OR 55 OR 57), (120 OR 123 OR 128), (144 OR 148)} in dictionaries of index II.

If there is only one buta string from the query, we may then search the OR combination of alternative buta strings (54_{—}120_{—}144 OR 54_{—}123_{—}144 OR 55_{—}123_{—}144 OR 57_{—}120_{—}148) in dictionary of index I instead of searching the target buta string 56_{—}124_{—}145. This, for example, will result in three matched documents having alternative buta strings close to but not the target buta string 56_{—}124_{—}145, as shown in FIG. 4.

If there are more than one buta strings from the query, for example, for the search span in dictionary of index I {56_{—}124_{—}145, 77_{—}124_{—}145, 198_{—}124_{—}145, . . . }, it becomes {(54_{—}120_{—}144 OR 54_{—}123_{—}144 OR 55_{—}123_{—}144 OR 57_{—}120_{—}148), 77_{—}124_{—}145, 198_{—}124_{—}145, . . . }, where the second and third buta strings may be substituted by other OR operations.

The document search in dictionary of index I involving more than one buta string {56_{—}124_{—}145, 77_{—}124_{—}145, 198_{—}124_{—}145, . . . } is conducted by taking an AND operation among the buta strings, such as {(56_{—}124_{—}145) AND (77_{—}124_{—}145) AND (198_{—}124_{—}145) . . . }. Thus the search span will be {(54_{—}120_{—}144 OR 54_{—}123_{—}144 OR 55_{—}123_{—}144 OR 57_{—}120_{—}148) AND (77_{—}124_{—}145) AND (198_{—}124_{—}145) . . . }, where the second and third buta strings may be substituted by other OR operations.

The document search in dictionary of index I may be expressed by a search span {(buta string 1) AND (buta string 2) AND (buta string 3) AND . . . }. Buta string 1 may be replaced with {(alternative buta string 1) OR (alternative buta string 2) OR (alternative buta string 3) OR . . . }. An alternative buta string is obtained by searching {[[(buta attribute value suggestion 1) OR (buta attribute suggestion 2) OR . . . ] for Red] AND [[(buta attribute value suggestion 1) OR (buta attribute suggestion 2) OR . . . ] for Green] AND [[(buta attribute value suggestion 1) OR (buta attribute suggestion 2) OR . . . ] for Blue]} in dictionaries of index II. Buta attribute value suggestions are found in dictionary of index II using a buta attribute range determined using a given tolerance and a target buta attribute value.

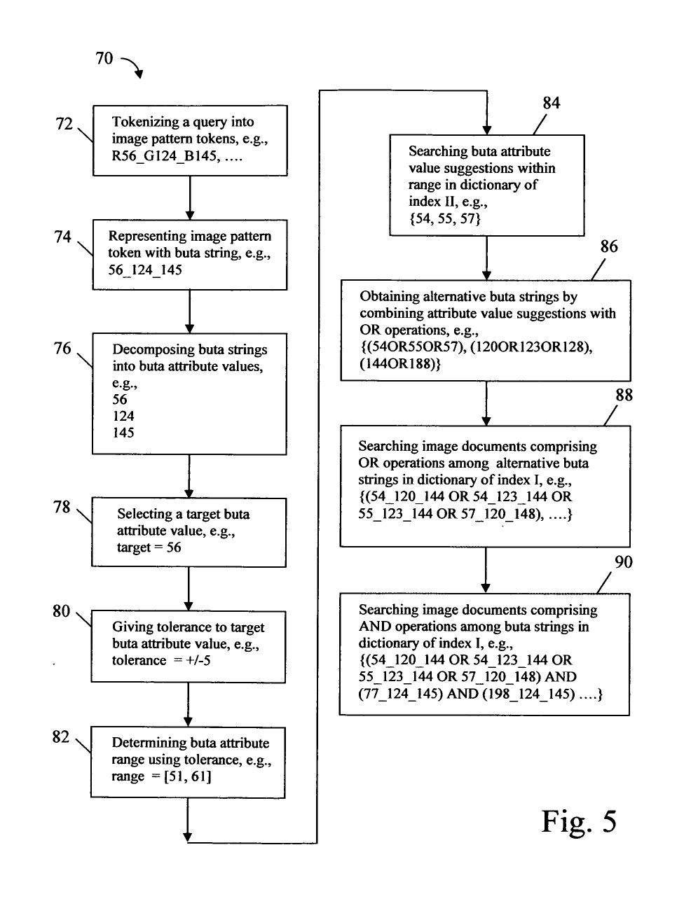

In one embodiment, a computer method for searching image documents is illustrated in FIG. 5. FIG. 5 contains a process 70 for searching image documents. In step 72, an query is tokenized into image pattern tokens, e.g., R56_G124_B145, . . . . In step 74, an image pattern token in represented by a buta string, e.g., R56_G124_B145 is represented by 56_{—}124_{—}145. In step 76, the buta string is decomposed into buta attribute values, e.g., 56_{—}124_{—}145 is decomposed into 56, 124, and 145. In step 78, a target buta attribute value is selected, e.g., target=56. In step 80, a tolerance is given to the target buta attribute value, e.g., tolerance=+/−5. In step 82, a buta attribute range is determined using the given tolerance, e.g., range=[51, 61]. In step 84, buta attribute value suggestions are searched in a dictionary of index II within the buta attribute range, e.g., {54, 55, 57}. In step 86, alternative buta strings are obtained by combining attribute value suggestions with OR operations, e.g., {(54 OR 55 OR 57), (120 OR 123 OR 128), (144 OR 148)}. In step 88, image documents are searched comprising OR operations among alternative buta strings in a dictionary of index I, e.g., {(54_{—}120_{—}144 OR 54_{—}123_{—}144 OR 55_{—}123_{—}144 OR 57_{—}120_{—}148), . . . }. In step 90, image documents are searched in dictionary of index I comprising AND operations among buta strings, e.g., {(54_{—}120_{—}144 OR 54_{—}123_{—}144 OR 55_{—}123_{—}144 OR 57_{—}120_{—}148) AND (77_{—}124_{—}145) AND (198_{—}124_{—}145) . . . }, in which a buta string may be replaced by OR operations among alternative buta strings.

Biological Unit of Text Abstraction (buta)

A concept is equivalent to a document including a non-word-based document. Recognizing a concept using computer is equivalent to searching a document using computer. A concept and a document can be represented by computer searchable buta (biological unit of text abstraction) strings. For example, a buta string may be “John Doe”, “123”, “128_{—}012_{—}234”, “abc2387xy56”, or others. The buta string must be computer readable, although it may not be readable to human.

The buta strings representing a document can be found by tokenizing the document into its tokens, which are represented with the buta strings. The buta string is a value. The buta string has name related to its value. For example, author=“John Doe”, height=“123”, x[12,23]=“123_{—}012_{—}234”, in which author, height, and x[12,23] are names.

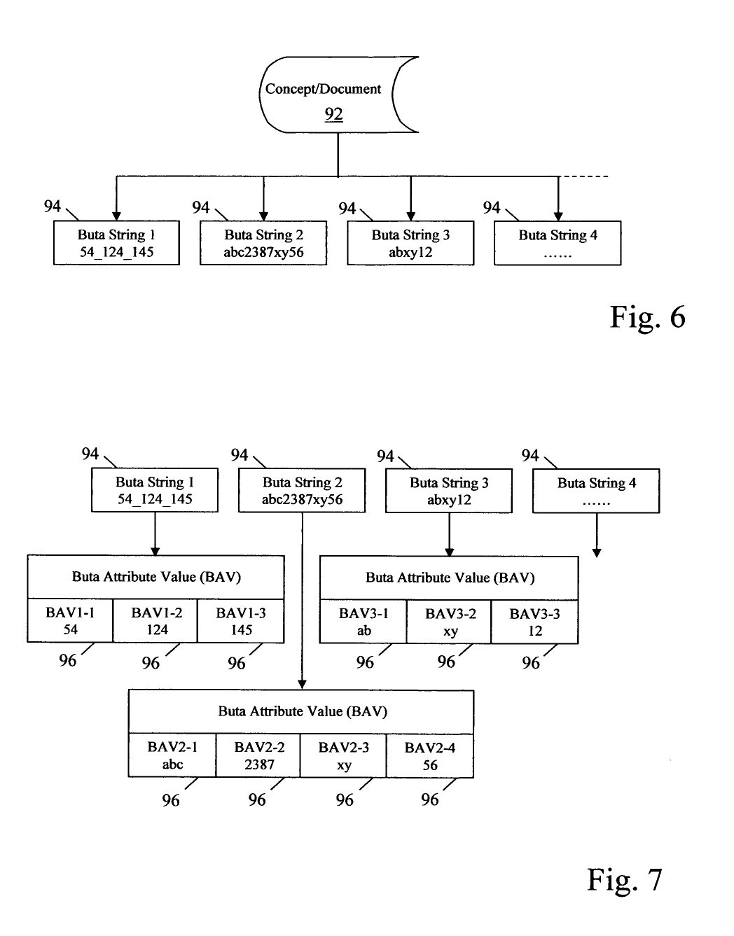

A computer recognizable concept and a computer searchable document 92 can be represented by a plurality of buta strings 94 as shown in FIG. 6. A buta string 94 can be further decomposed into a plurality of buta attribute values 96 as shown in FIG. 7.

A concept or a document is tokenized into a plurality of buta strings. Referring to FIG. 6, for example, document D1 (92) is tokenized into buta string 1 54_{—}124_{—}145, buta string 2 abc2387xy56, buta string 3 abxy12, and so on. A plurality of documents (D2, D3, . . . ) are then tokenized as well. Document D1 can be indexed by its buta strings, e.g., D1={54_{—}124_{—}145, abc2387xy56, abxy12, . . . }. For further example, document D2 (not shown) and document D3 (not shown) may be tokenized such as D2={abc2387xy56, abxy12, . . . } and D3={abxy12, . . . }, respectively. A dictionary of index I can be constructed by collecting all buta strings. A buta string relates to documents, such as: 54_{—}124_{—}145={D1, . . . }, abc2387xy56={D1, D2, . . . }, and abxy12={D1, D2, D3, . . . }. An example of dictionary of index I is illustrated in FIG. 8.

Each buta string is split into buta attribute values. Referring to FIG. 7, for example, buta string 54_{—}124_{—}145 becomes buta attribute values 54, 124, and 145. Buta string abc2387xy56 becomes buta attribute values abc, 2387, xy, and 56. Buta string abxy12 becomes buta attribute values ab, xy, and 12. A dictionary of index II is constructed by decomposing buta strings into buta attribute values. Dictionary of index II relates a buta attribute value to buta strings. Dictionary of index II is also called buta attribute value dictionary. Buta attribute values in dictionary of index II are sorted in ascending order. An example of dictionary of index II is illustrated in FIG. 9.

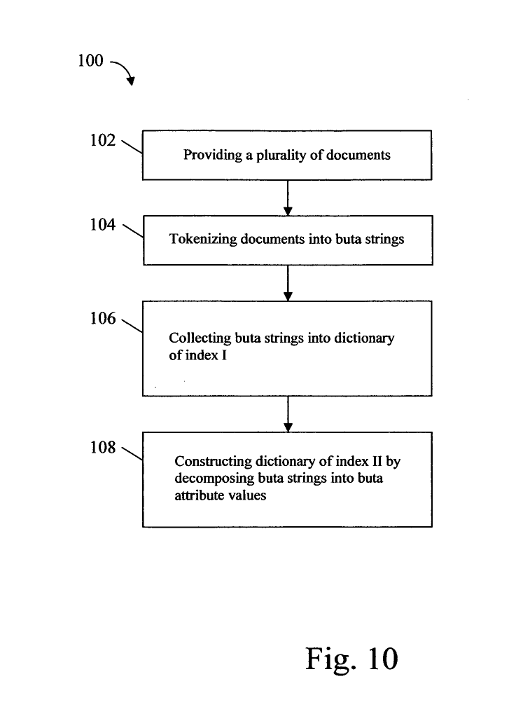

In one embodiment, a computer method for constructing dictionaries of index I and II is illustrated in FIG. 10. FIG. 10 contains a process 100 for constructing dictionaries of index I and II. In step 102, a plurality of documents are provided. In step 104, each document is tokenized into buta strings. In step 106, buta strings are collected to construct dictionary of index I, which relates a buta string to documents. In step 108, buta strings are decomposed into buta attribute values to construct dictionary of index II, which relates a buta attribute value with buta strings.

All buta strings such as 54_{—}124_{—}145, abc2387xy56, and abxy12 can be searched with controlled tolerance. For example, buta string abxy12 is decomposed in buta attribute values ab, xy, and 12. For buta attribute value ab, the tolerance given may be “tolerance=any arrangement orders of characters a and b”, for buta attribute value xy, the tolerance given may be “tolerance=0”, and for buta attribute value 12, the tolerance given may be “tolerance=+/−1”. Thus, even though the buta attribute value is not numeric, a tolerance can be given as well as a numeric buta attribute value.

After a target document is tokenized into buta strings, the target document represented by a plurality of buta strings can be searched with controlled tolerance similar to the method shown in FIG. 5. Steps 72 and 74 may be combined as tokenizing a target document into a plurality of buta strings.

Since a concept can be tokenized into buta strings similar to a document, the computer method disclosed in the disclosure, in particular in the processes given in FIG. 5 and FIG. 10, can be extended from the searching documents to recognizing concepts in computer. Accordingly, “document(s)” is replaced with “concept(s)”, and “searching document(s)” is replaced with “recognizing concept(s)” in related steps.

Furthermore, a target concept is tokenized into buta strings, the target concept represented by a plurality of buta strings can be searched and/or recognized with controlled tolerance similar to the method shown in FIG. 5. Steps 72 and 74 may be combined as tokenizing a target concept into a plurality of buta strings.

Image documents and documents provided in the related steps in the processes given in FIG. 1, FIG. 5, and FIG. 10 may be from a data source or the Internet.

It is understood that the processes given in FIG. 1, FIG. 5, and FIG. 10 for searching image documents, searching documents including non-word-based documents, and recognizing concepts are performed in computer, and comprise related computer executed steps.

While the present disclosure has shown and described exemplary embodiments, it will be understood by those of ordinary skill in the art that various changes in form and details may be made therein without departing from the spirit and scope of the present disclosure, as defined by the following claims.

1. A computer method for searching image documents comprising the computer executed steps of:
tokenizing an query into image pattern tokens
representing said image pattern tokens with buta strings,
decomposing said buta strings into buta attribute values,
selecting a target buta attribute value from said buta attribute values,
giving a tolerance to said target buta attribute value,
determining a buta attribute range using said given tolerance,
searching buta attribute value suggestions in a dictionary of index II within said buta attribute range, wherein said dictionary of index II relates a buta attribute value to buta strings,
obtaining alternative buta strings comprising OR operations among said buta attribute value suggestions,
searching image documents comprising OR operations among said alternative buta strings in a dictionary of index I, wherein said dictionary of index I relates a buta string to image documents.

2. The computer method of claim 1 further comprising:
searching image documents comprising AND operations among said buta strings in said dictionary of index I.

3. The computer method of claim 1 further comprising:
providing a plurality of image documents,
tokenizing each of said plurality of image documents into image pattern tokens,
collecting said image pattern tokens in a master collection of image pattern tokens,
transforming said master collection of image pattern tokens into said dictionary of index I by representing said image pattern tokens with buta strings,
constructing said dictionary of index II by decomposing said buta strings into buta attribute values.

4. The computer method of claim 3 wherein said provided image documents are from a data source.

5. The computer method of claim 3 wherein said provided image documents are from the Internet.

6. A computer method for searching documents comprising the computer executed steps of:
tokenizing a target document into buta strings,
decomposing said buta strings into buta attribute values,
selecting a target buta attribute value from said buta attribute values,
giving a tolerance to said target buta attribute value,
determining a buta attribute range using said given tolerance,
searching buta attribute value suggestions in a dictionary of index II within said buta attribute range, wherein said dictionary of index II relates a buta attribute value to buta strings,
obtaining alternative buta strings comprising OR operations among said buta attribute value suggestions,
searching documents comprising OR operations among said alternative buta strings in a dictionary of index I, wherein said dictionary of index I relates a buta string to documents.

7. The computer method of claim 6 further comprising:
searching documents comprising AND operations among said buta strings in said dictionary of index I.

8. The computer method of claim 6 further comprising:
providing a plurality of documents,
tokenizing each of said plurality of documents into buta strings,
collecting said buta strings into said dictionary of index I,
constructing said dictionary of index II by decomposing said buta strings into buta attribute values.

9. The computer method of claim 8 wherein said provided documents are from a data source.

10. The computer method of claim 8 wherein said provided image documents are from the Internet.

11. A computer method for recognizing concepts comprising the computer executed steps of:
tokenizing a target concept into buta strings,
decomposing said buta strings into buta attribute values,
selecting a target buta attribute value from said buta attribute values,
giving a tolerance to said target buta attribute value,
determining a buta attribute range using said given tolerance,
searching buta attribute value suggestions in a dictionary of index II within said buta attribute range, wherein said dictionary of index II relates a buta attribute value to buta strings,
obtaining alternative buta strings comprising OR operations among said buta attribute value suggestions,
recognizing concepts comprising OR operations among said alternative buta strings in a dictionary of index I, wherein said dictionary of index I relates a buta string to concepts.

12. The computer method of claim 11 further comprising:
recognizing concepts comprising AND operations among said buta strings in said dictionary of index I.

13. The computer method of claim 11 further comprising:
providing a plurality of concepts,
tokenizing each of said plurality of concept into buta strings,
collecting said buta strings into said dictionary of index I,
constructing said dictionary of index II by decomposing said buta strings into buta attribute values.
